(19) United States
(12) Patent Application Publication
(10) Pub. No.: US 2014/0081663 A1
(43) Pub. Date: Mar. 20, 2014

(54) On-line system and method for providing medical data to patient

(71) Applicants: Vito John Calandro, II, Denver, CO (US); Tracy Ann Paeschke, Denver, CO (US)

(72) Inventors: Vito John Calandro, II, Denver, CO (US); Tracy Ann Paeschke, Denver, CO (US)

(21) Appl. No.: 13/987,990

(22) Filed: Sep. 20, 2013

Related U.S. Application Data
(60) Provisional application No. 61/744,183, filed on Sep. 20, 2012.

(51) Int. Cl. G06F 19/00

(52) U.S. Cl. CPC G06F 19/322
USPC 705/3

(57) ABSTRACT

A system and method for on-line delivery of a patient's medical data to the patient includes the method steps of: a) providing an Internet-accessible service website; b) providing at least one Sign-up web page on the service website with blanks for entering the patient's email address, etc.; c) providing a medical data request form on the service website; d) offering at least one service pricing plan on the service website; and e) upon receipt of payment for a service pricing plan and a signed medical data request form, creating an on-line patient system chart and downloading electronic medical data to it from the patient's healthcare facility chart on the healthcare facility's computer, and scanning or photographing and forwarding any paper files from the healthcare facility's chart for the patient, the patient system chart being viewable on-line using the patient's Internet-accessible computerized mobile device.

### CROSS REFERENCE TO RELATED DOCUMENT

Benefit is claimed under 35 USC 119(e) of the filing date of provisional U.S. patent application No. 61/744,183, filed on Sep. 20, 2012 and entitled “On-line System and Method for Providing Medical Data to Patient”.

### BACKGROUND OF THE INVENTION

1. Technical Field

The present invention relates to an on-line method and system for collecting a patient's medical data/chart and promptly making it available to the patient, or the patient's appointed representative, particularly for making a patient's electronic and print medical chart accessible to the hospital inpatient during the patient's hospital stay.

2. Background Information

The days of the past where the patient was expected to lie silently in a hospital bed are long gone, but the days of the future where the patient is fully empowered to participate in decisions regarding his or her health have not yet fully arrived. The on-line system and method of the present invention herald those future days by allowing even the bed-bound patient to have up-to-the-minute information about his or her medical condition. The present system and method provide a patient with the opportunity to review his or her chart, laboratory results, test results, and other medical data within 24 hours of hospital inpatient admission, or within a timely fashion. The present system presents a patient's medical data to the patient almost contemporaneously with (i.e., within hours of) a medical action, such as a medical treatment, operation, change in medication, or laboratory test—just about as soon as the results are available. Patient data is collected by, and provided through, an Internet-accessible service called “CZ” herein, although any name can be used for the service. The patient, or the patient's appointed representative, registers for this relatively inexpensive service, and, when notified, goes on-line and reviews his or her medical data at his or her convenience.

### BRIEF SUMMARY OF THE INVENTION

The present invention includes a method for collecting and delivering a patient's medical data to the patient, which includes the steps of: a) providing an Internet-accessible service website; b) providing at least one Sign-up web page on the Internet-accessible service website with a plurality of blanks for entering patient registration information, the patient registration information comprising the patient's email address, and the name of a healthcare facility at which the patient is registered for admission; c) providing a medical data request form with at least one signature blank on a Contract web page of the Internet-accessible service website; d) offering at least one service pricing plan on a Pricing web page of the Internet-accessible service website; and e) upon receipt of payment for the at least one service pricing plan and a signed medical data request form, creating an on-line patient system chart and downloading medical data to it from the patient's chart at the healthcare facility. The service does not classify, analyze, or categorize collected data. At the end of the patient-designated block of time, that patient's medical data is archived.

The present invention also includes an on-line system for collecting and delivering patient medical data for access by a patient, which includes: (a) at least one Internet-accessible patient service-capable Internet-accessible computerized mobile device, at least one healthcare facility Internet-accessible service computer associated with a computer at a healthcare facility and a secure Local Area Network at the at least one healthcare facility, and an Internet-accessible service computer and at least one service Internet-accessible computerized mobile device; (b) a service website accessible from the patient Internet-accessible computerized mobile device; (c) a service server linked to the Internet via a service datacenter firewall; and (d) the service computer being linked to a Web server, and at least one other server.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a schematic view of a system for providing a patient's medical data to the patient according to the present invention, showing a CZ platform;

FIG. 2 is a schematic overview of a system for providing a patient's medical data to the patient according to the present invention;

FIG. 3 is a schematic view of a patient registration portion of the system for providing a patient's medical data to the patient according to FIGS. 1 and 2;

FIG. 4 is a schematic view of document scanning and Optical Character Recognition processing portions of the system for providing a patient's medical data to the patient according to FIG. 2;

FIG. 5 is a schematic of a document scanning portion of the system for providing a patient's medical data to the patient according to FIG. 2;

FIG. 6 is a schematic view of an Electronic Medical Record system integration portion of the system for providing a patient's medical data to the patient according to FIG. 2;

FIG. 7 is a schematic view of a system for accessing a patient's medical charts according to the present invention;

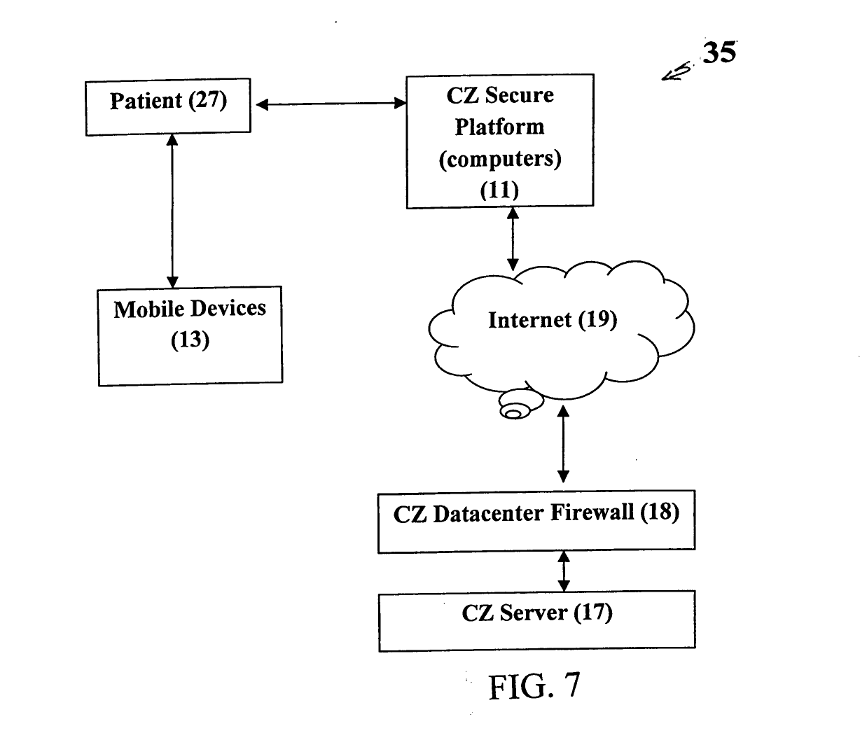

FIG. 8 is a flowchart showing a method of providing a patient's medical data to the patient according to the present invention;

FIG. 9 is a schematic view of a medical data delivery system according to the present invention;

FIG. 10 is an exemplary view of a web page of a medical data delivery system according to the present invention;

FIG. 11 is an exemplary view of a “Features” web page of a medical data delivery system according to the present invention;

FIG. 12 is an exemplary view of a “Pricing” web page of a medical data delivery system according to the present invention;

FIG. 13 is a view of an exemplary “Events” web page of a medical data delivery system according to the present invention; and

FIG. 14 is a view of an exemplary “Contract” web page of a medical data delivery system according to the present invention.

### DETAILED DESCRIPTION OF THE INVENTION

In the following description, like reference characters designate like or corresponding parts throughout the several views. Also, in the following description, it is to be understood that such terms as “front,” “within,” and the like are words of convenience and are not to be construed as limiting terms. Referring in more detail to the drawings, the invention will now be described.

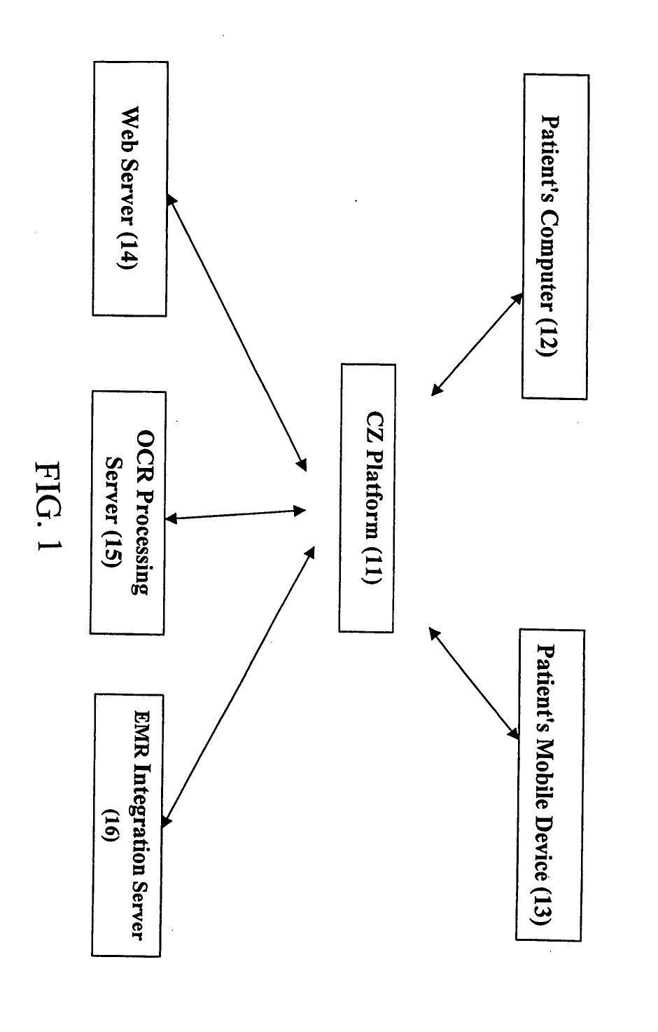

According to the schematic of FIG. 1, the CZ platform 11 is linked to the patient's computer 12 and/or one or more of the patient's computerized mobile devices 13, which are Internet-accessible. The on-line medical collection and delivery service of the present invention is called “CZ” herein. The CZ platform 11 is also linked to the Web server 14, an OCR (Optical Character Recognition) processing server 15, and an EMR (Electronic Medical Record) integration server 16.

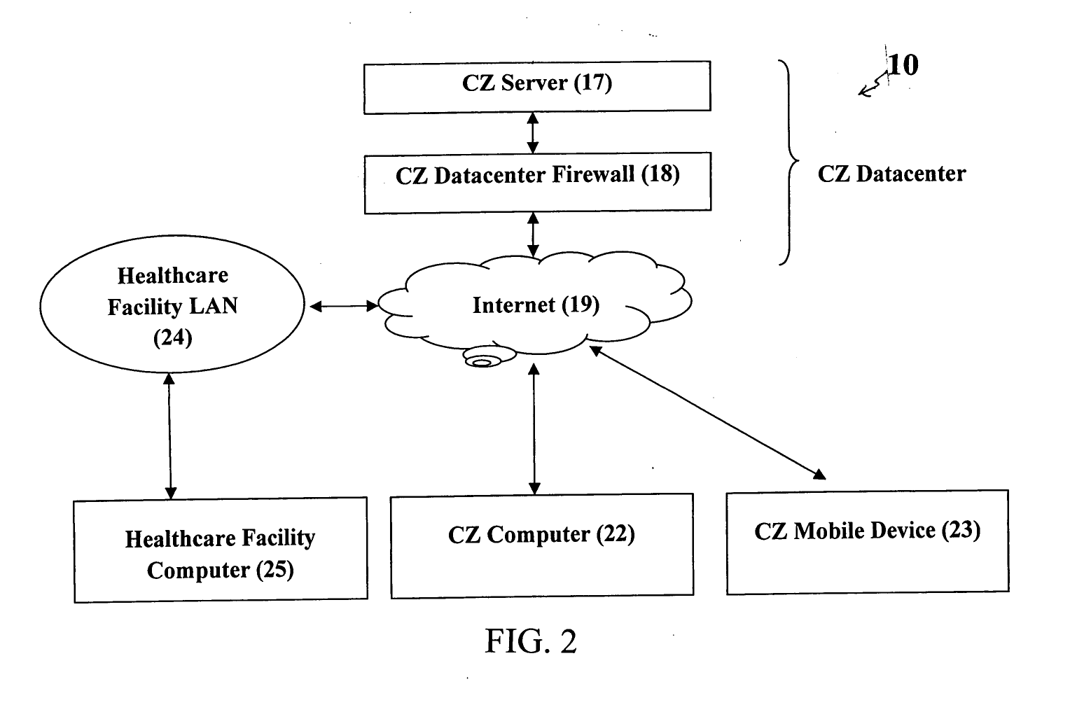

The FIG. 2 overview shows the CZ server 17 being linked to the Internet 19 via a CZ datacenter firewall 18. The CZ server 17 is for storing the user data. The CZ server 17 and firewall 18 are in the CZ datacenter 21. The CZ firewall 18 is provided by the PCI (Payment Card Industry)/HIPAA (Health Insurance Portability and Accountability Act) compliant date center. HIPAA is meant to protect the privacy of patient medical records and other information. The healthcare facility 20 has a secure LAN (computer local area network) 24, and a computer 25 at the healthcare facility 20 where patient records are stored. Continuing with FIG. 2, the CZ service computer 22 and computerized mobile devices 23 also use the Internet 19. The Internet-accessible service computer 22 and Internet-accessible mobile devices are used for scanning medical charts and print documents (including handwritten notes, laboratory test results, etc.) related to client-patients. A camera function of a CZ computerized mobile devices 23, preferably a Smartphone or tablet computer, can be used to take photos of patient documents at the healthcare facilities where the records are.

A suitable healthcare facility 20 herein includes hospital inpatient, meaning that the patient has been admitted to the hospital; out-patient at a clinic or hospital, meaning that the patient visits the clinic or hospital or the like for less than 24 hours for treatment, which could include an acute care center or urgent care facility; a long term care facility, meaning that the patient requires long term care, such as a nursing home or a rehabilitation center; a hospice for the terminally or seriously ill patient; or any other location where patients are treated.

By “smartphone” herein is meant any Internet-accessible computerized mobile device with capability for receiving and displaying information from the service of the present on-line system, so that the smartphone is capable of being used to carry out the present invention (i.e., the mobile device is “service-capable”). A smartphone is a cellular phone that can function as a computer, with a mobile operation system and capability for high speed data access (e.g., via WiFi).

Some states in the US require that a patient's medical records be handed over to the patient within 24 hours, or within a reasonable amount of time, of the patient's request for his or her records. An important application for the present record delivery system 10 is therefore hospital inpatient. Most hospital stays range between 24 hours and a week. The record delivery system 10 permits the patient to view his or her medical records while the patient is an inpatient, which is when many patients desire access to them. Many patients believe that being able to review their own records allow them to make more informed decisions regarding their own care, for example, whether to undergo a particular medical procedure or operation the next day. The same is true of a pediatric patient's parent or other patient representatives where the patient is too young or infirm, etc. to make his or her own decisions. In fact, the medical records are frequently delivered to the patient's computerized device (e.g., desktop or laptop computer or mobile device) by the system 10, where they are accessible by the patient 27, almost contemporaneously with the inpatient treatments, procedures, etc. on which the latest medical records are based. Thus, a patient 27 having a particular laboratory procedure in the morning can view the results on his or her smartphone that afternoon, which may even be before the patient's doctor views the results.

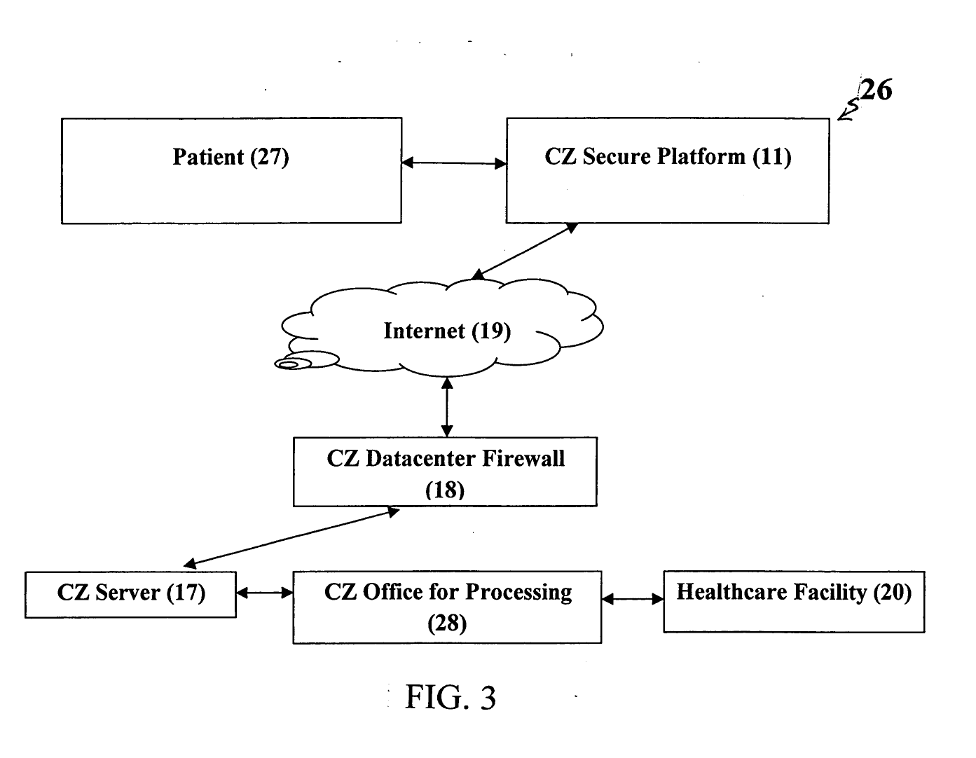

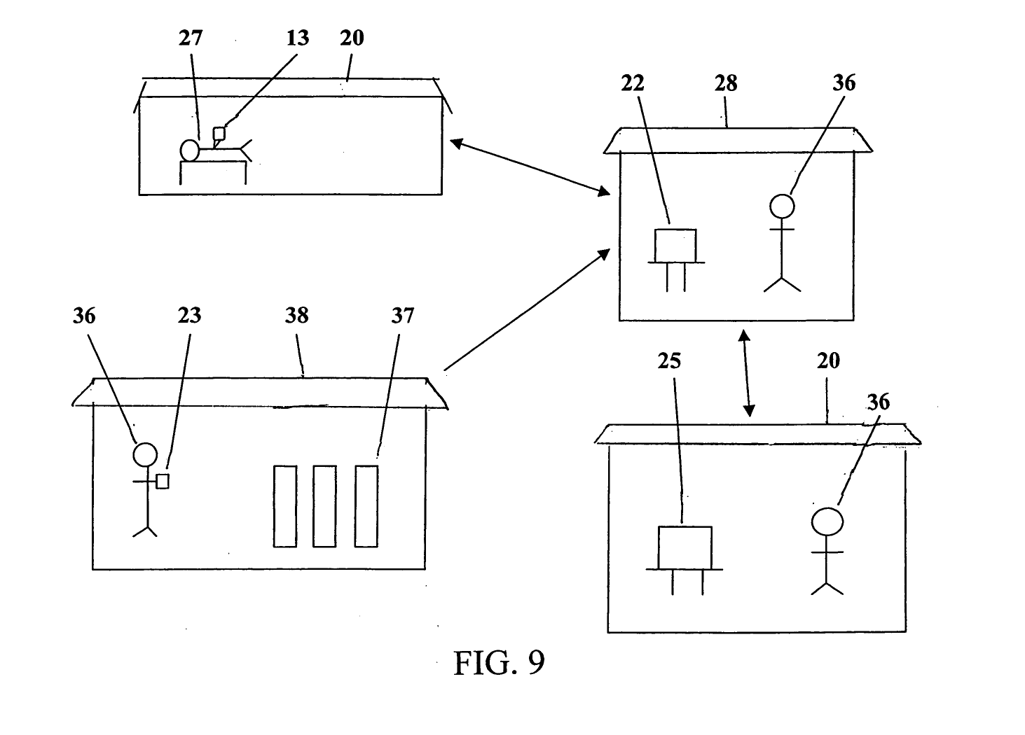

As seen in FIG. 3, the medical data collection and delivery system 10 includes a registration portion 26. The client-patient 27 initiates contact on his or her Internet-accessible computer 12 or computerized mobile device 13 via the CZ service secure platform 11 and the Internet 19. This may be done prior to the prospective patient's admission to the hospital or other healthcare facility 20, or from the patient's hospital room (see FIG. 9). The CZ service server 17 is linked to the Internet 19 via a CZ datacenter firewall 18. User registration is performed at the CZ server 17. The patient request is processed by CZ (service) personnel 36 in a CZ office 28. The patient 27 either brings the completed legal medical data request/contract from the website 31 to the hospital or other healthcare facility 20 when he or she goes to be admitted, or the completed legal medical data request is emailed or otherwise sent to the hospital or other healthcare facility 20. Once the hospital or other healthcare facility 20 approves the patient medical data request, the patient's charts and other medical data are collected from the requested hospital, or from files at one or more healthcare facilities 20.

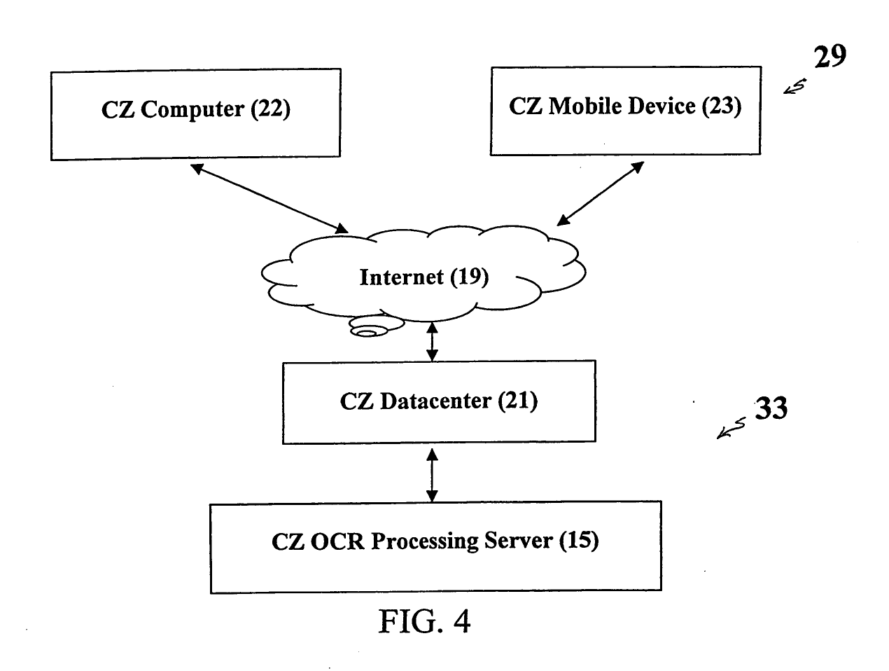

As seen in FIGS. 4 and 9, the medical data collection and delivery system 10 includes a document scanning portion 29 and OCR processing portion 33. The service employee 36 (or service independent contractor) accesses the healthcare facility computer 25 to generate charts in pdf, doc, docx, xls, xlsx, etc., and uploads them to the CZ website 31. The service employee 36, often called a “field engineer”, searches for any print documents 37. If any are found, the service employee 36 goes to the print file site and physically scans the patient's print (usually paper) documents using a service computerized device 22, 23. The CZ system includes an Optical Character Recognition (OCR) processing server 15 to which the service employee 36 uploads his scans of the print documents 37 via the CZ datacenter 21 using the Internet 19. Some hospitals/healthcare facilities 20 have gone paperless, in which case there should not be any print files to upload, only electronic files.

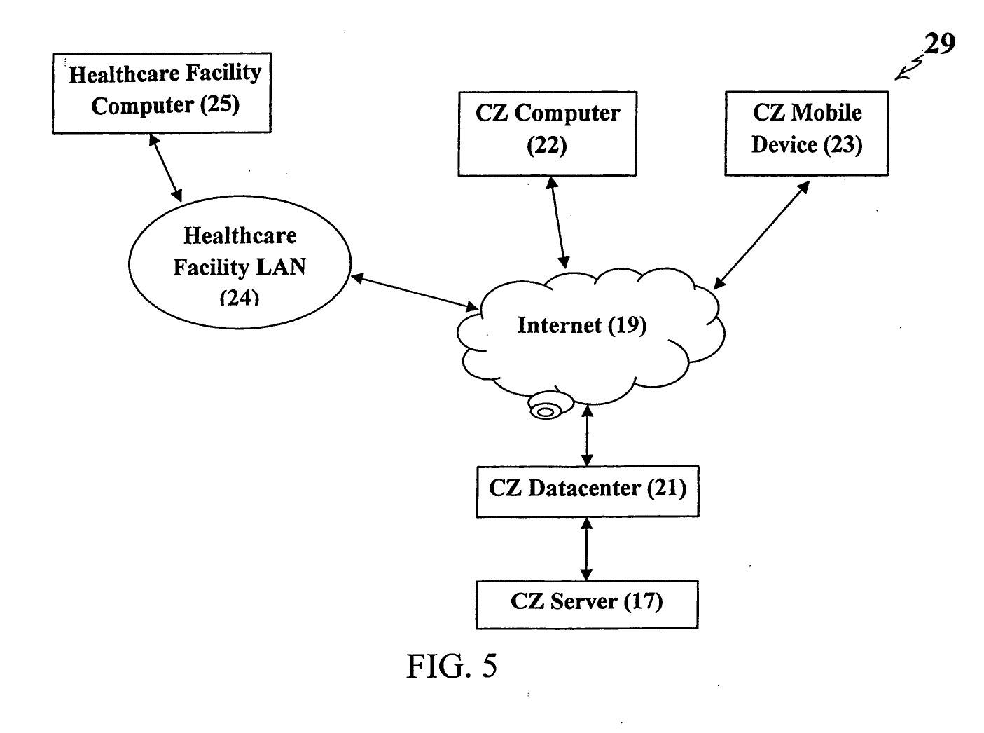

As seen in FIG. 5, the medical data collection and delivery system 10 includes a document scanning portion 29. The service website 31 has the capability of receiving both (a) hospital electronic records accessed from the hospital database, and (b) scanned-in records found during a hand search of print/paper medical facility records for the client-patient 27. Once these print/loose records 37 are found during the hand search, they are scanned into the present system 10. The hospital electronic records and the scanned-in hand search records are collectively called “collected data” 39 here.

In regard to the hospital electronic records, the CZ service employee 36 (where permission granted) accesses the healthcare facility computer 25, generates charts for the requesting client-patient in pdf, doc, docx, xls, xlsx, etc., and uploads them to the service website 31 (see FIG. 9). No other patients' records are accessed—only the records/chart of the requesting client-patient. In regard to the “hand search”, the service employee 36 searches for any print medical documents 37 attached to the patient's name in previous or current healthcare facilities 20 where the patient 27 has been or is being treated. Many hospitals and other healthcare facilities 20 still maintain written files 37. Even those healthcare facilities 20 that maintain electronic files often maintain a paper file 37, too. Some physicians like to maintain a separate paper file 37 apart from and in addition to the hospital electronic file. This paper file 37 may be kept in a file in the physician's office, or in a nurses' station in the hospital or other facility. Such print files 37 (term includes loose documents) may include handwritten physician or nurse's notes, x-ray or laboratory results, or any records that have not been logged into the hospital's electronic records as of the time of the hand search, for whatever reason.

Many patients are quite interested in receiving and studying their physician's notes, laboratory results, drug intake, test results (e.g., MRI-Magnetic Resonance Imaging), etc. Doing so can give them a feeling of control over what might otherwise be a painful and/or fearful experience. It helps the patient make informed decisions about upcoming tests and his/her care. It is also advantageous to physicians, nurses, and office personnel if the patient does not have to contact them every time the patient has a test to find out the test results (particularly negative/normal results), although the medical practitioner still communicates closely with the patient.

If any such print files 37 are found, the service employee 36 in the file room, or wherever the print files are kept, at the primary care physician's office 38 or other medical facility, or elsewhere, scans the patient's print/paper documents using his or her work computerized device 23, as illustrated at the bottom of FIG. 9, or any high speed portable scanner. The service employee 36 can take photos of the patient-care related documents, if any, and upload them to the CZ secure server 17 via the CZ datacenter 21 using the Internet 19. Having a service employee 36 perform this task is beneficial in that an interested individual can often find results in a file room, medical laboratory, etc., that just an electronic request for, or transference of, data would not unearth. Collected data for patient 27 will be much more thorough with both the existing electronic record and scanned-in hand search results.

Collected data 39 herein may include physician's notes, prescribed medications, temperature charts, and laboratory results, such as blood tests, x-rays, echocardiograms, CAT (computerized tomography) scans, etc. The collected medical data 39 provides a snapshot of the patient's medical records at the point in time they are collected.

Thus, the medical data delivery method 30 includes the following steps: a) receiving on-line registration with CZ secure platform 11 from a patient/prospective client; b) confirming information from the patient; c) assigning and sending the patient username and password for login to the CZ computer; d) awaiting a grant of access by healthcare facility to that patient's records; e) accessing healthcare facility files by the CZ service; f) generating charts and uploading them to the medical data delivery website 31; g) searching for and, if any are found, scanning print documents using computerized device; and h) uploading any photographs of the print documents to the CZ secure server 17 using the Internet 19.

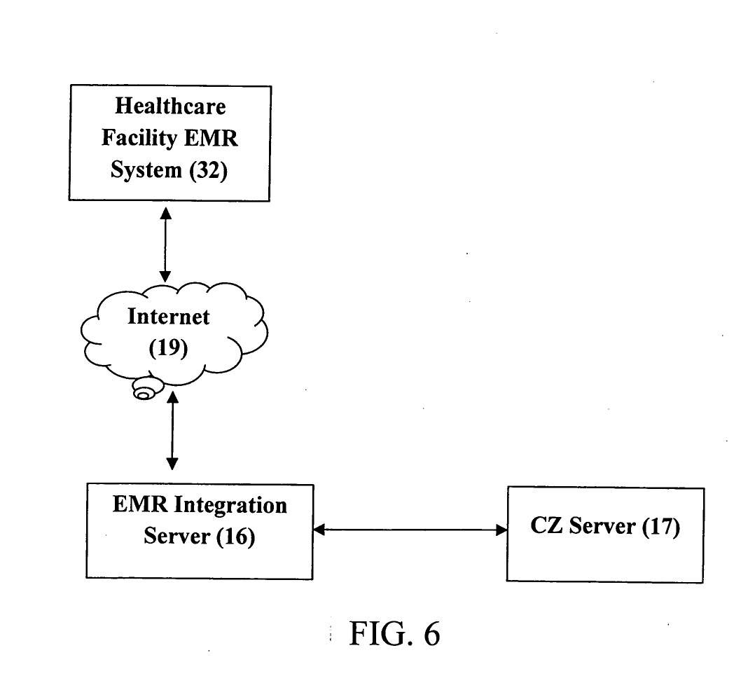

A field engineer of the CZ service goes onsite where the patient's charts and other data are and scans the patient's printed medical records with his/her Internet-accessible computerized mobile device, assuring that digital medical data is collected. This collection period is short term; no long term management of patient records by service personnel is involved. Since medical matters are often urgent, the collection work herein can be done within 24 hours, sometimes within minutes, so the patient can rapidly review his or her medical data. In that case, when the patient registers, he or she chooses the rapid response service option with daily collection/data refreshment. Long term care patients, for example, may choose the standard response service option with data refreshment once or twice per month. The patients 27, or their appointed representatives, review the data themselves privately (no written reports are provided, though the data collection can be printed from the computer).

Where permission has been granted by the hospital for CZ's service to tap into the hospital's computer system for that patient, the CZ system uses Electronic Medical Record (EMR) system integration 32, as shown in FIG. 6. The EMR system of the healthcare facility 20 is accessible via the Internet 19. The CZ EMR integration server 16 connects with the EMR system at the healthcare facility 20. Collected data is saved to the CZ secure server 17.

Lastly, as seen in FIG. 6, the on-line data delivery system 10 includes an accessing records portion 35 (or subsystem). Using the patient's computer 12 or computerized mobile device 13, the patient 27, who is now a CZ client, or the patient's appointed representative, goes on-line and logs onto the CZ secure website 31, and accesses the patient's collected medical records. No device other than the Internet-accessible computer, or Internet-accessible tablet computer, Smartphone, or other Internet-accessible computerized mobile device is needed/used. The medical data may be printed on a printer if desired. Accessing the CZ website 31 via the Internet 19 is most conveniently and privately done using the patient's computerized mobile device 13. Preferred computerized mobile devices 23 herein are smartphones and tablet computers. The patient's legally appointed representative, or the patient, can review the medical data while on the move, in a meeting, or anywhere he or she can access the Internet 19. For example, a properly appointed adult child of an elder in a nursing home can review his or her parent's medical records any time and from almost anywhere.

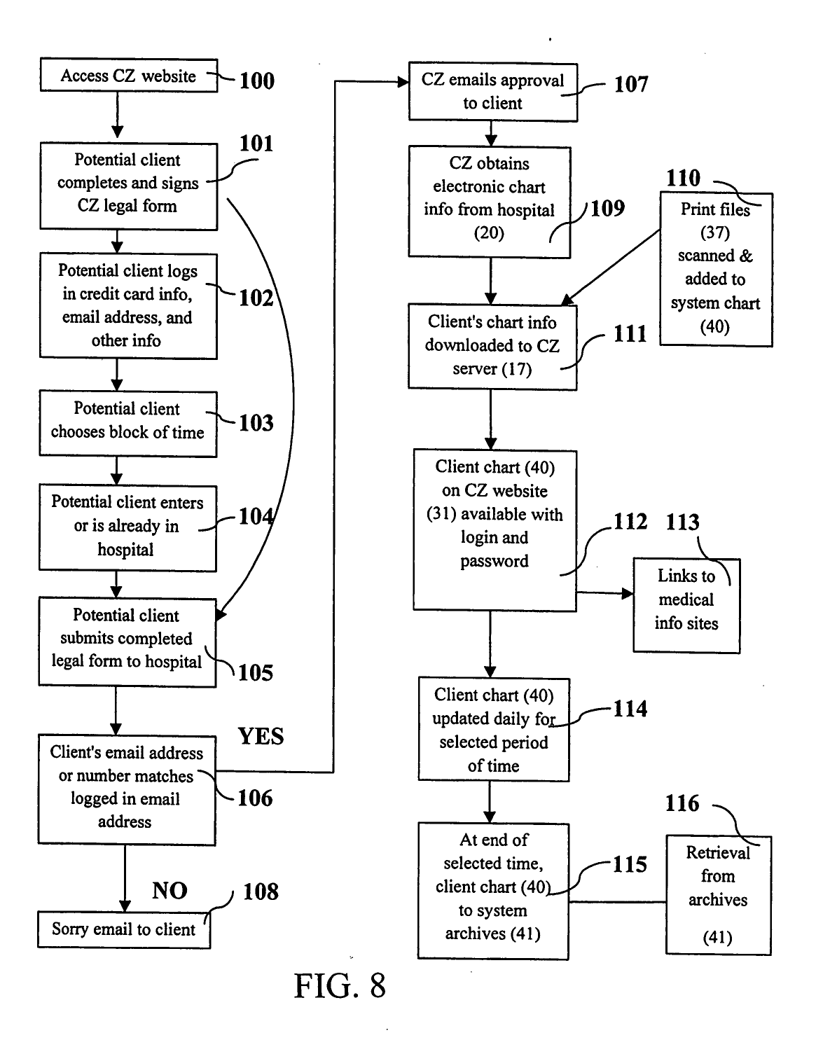

In regard to the medical records delivery method shown in FIG. 8, the registration portion 26 of the method 30 includes the following steps: a) providing an Internet-accessible (CZ) website 31 accessible to the potential client/patient 27, as seen in Block 100; b) providing a page on the Internet-accessible website 31 with blanks for entering patient registration information, such as credit card information, email address, social security number, previous healthcare facilities where the patient was treated in the past, as seen in Block 102; c) providing legal medical data request forms with at least one blank on a page of the website 31 for the potential client/patient 27 to complete and sign, as seen in Block 101; and d) offering a block of time selection on a page of the website 31, as seen in Block 103, which may correspond to the expected length of the hospital stay. Sometime (e.g., days or weeks) after completion of on-line registration, the patient 27 enters the hospital or other healthcare facility 20, as seen in Block 104. Alternatively, the patient 27 may register having just been admitted to the hospital or other healthcare facility 20. The service of the present invention does not update the medical data collection once the designated block of time has lapsed.

The method 30 preferably further includes the steps, following step c), of: e) receiving the completed legal medical data form, and matching user/patient-submitted registration information, including the patient's email address and any social security number, provided during the registration portion 26 against the email address, social security number, etc. provided by the patient at check-in at the current hospital or other healthcare facility 20, as seen in Blocks 105 and 106 of FIG. 8, respectively; and f) if the registration information is matched, emailing approval of service to the email address provided by the client/patient 27, as seen in Block 107. If no match of information is found, the method includes emailing a “sorry” message to the client/patient 27 declining service, as seen in Block 108. If a duly appointed representative of the patient 27 has proper written approval signed by the patient 27 or a court, the patient's representative may follow the steps herein in the patient's place. Step e) is done to assure that the person who filled out the service registration data request form is the same person (patient 27) the particular hospital admits. This is an effort to ensure that an unauthorized third person cannot access the patient data collection on-line.

Continuing with FIG. 8, the medical data delivery method 30 continues with the following steps: g) forwarding the signed patient request to decision makers (appointees) at the appropriate healthcare facility or facilities 20, and waiting for approval from the healthcare facility appointee; h) collecting digital/electronic medical data for the patient by (1) accessing the healthcare facility's computer 25 for the subject patient's files, as seen in Block 109, and by (2) receiving the scanned results of a physical hand search conducted at the primary physician's office 38 or other medical facility for any print/paper medical data (if the healthcare facility has any paper files), as seen in Block 110; and i) downloading all of the patient's collected medical data to the service's (CZ's) server 17, as seen in Block 111 of FIG. 8. The client system chart 40 is then available on the service website 31 with a login and password, as seen in Block 112.

The present method 30 preferably further includes the steps, following step i), of: j) updating the patient's medical data for a designated frequency (e.g., daily) during the designated block of time, as seen in Block 114 (repeating steps h-k); and k) at the end of the patient-designated block of time, the patient's medical data/chart 40 is sent to the system archives 41, as seen in Block 115. In regard to step m), the healthcare facility 20 may also require repetition of step g): forwarding the signed patient request, for successive days of the hospital stay (designated block of time). The patient medical data is archived a few days after the designated block of time has expired. In order to minimize security problems and avoid missing data that was recently added to previous healthcare facility files, the service-collected data is not updated once the designated block of time has lapsed. Unless the patient has chosen an option to view the chart at a later date, the patient's collected data 39 is deleted once the time period (e.g., 7 years) required by law (e.g., HIPAA) has expired.

The “block of time” website page preferably includes an item choice the patient may go back in and select in order to extend the designated block of time, which requires another signature by the patient 27, and resubmission and approval of the legal medical data request form. The patient may find, for example, that he or she will be in the hospital a few extra days, in which case the patient can go on the service website 31 and extend the block of time. The method 30 preferably includes the step of: providing a number of links to medical information sites on the website 31, as seen in Block 113, for researching medical words, normal laboratory result ranges, etc. found in the medical data.

There are several key periods of time involved in the present invention: the inpatient time period during which the patient 27 is in the hospital (e.g., 1-7 days), long term care facility or other healthcare facility 20; the plan time period, which is how long the patient signed up for the service (e.g., 3 or 4 days); and the archival time period, which begins when the system 10 automatically transfers the patient's system chart 40 to the system archives 41 and ends with deletion of the patient's system chart 41 at the end of the time period the patient's state requires that such records be maintained. There is also the time between when the user 27 signs up for the CZ service and when (s)he enters the hospital or other healthcare facility 20.

The medical data delivery system 10 includes: (a) at least one patient Internet-accessible computerized mobile device 13, at least one Internet-accessible service computer 22 associated with a computer 32 at least one healthcare facility 20 and a secure Local Area Network 24 at the healthcare facility 20, and an Internet-accessible service computer and at least one service Internet-accessible computerized mobile device 23; (b) a service website 31 accessible from the patient computerized mobile device 13; (c) a service server 17 linked to the Internet 19 via a service datacenter firewall 18; (d) the service computer being linked to a Web server 14, an Optical Character Recognition processing server 15, and an Electronic Medical Record integration server 16.

The block of time selected by the patient during registration depends on their circumstances. A block of time selected may be, for example, one week with an option to view the data again at a later date for a selected period of time. Some patients will select a block of time equal to the expected hospital stay plus a few days.

The Internet-accessible computerized mobile device of the present invention is preferably a Smartphone, or a tablet computer, not a portable memory device for storing medical records. No special, separate device is needed to use the service of the present invention.

The service of the present system 10 does not maintain a central medical data registry. Rather than being a long-term obligation to maintain a cumulative central database of medical records, CZ provides a collected data “snapshot” at a point in time (for one three day hospital stay, for example) for one patient. In the present system 10, a patient's collected data is archived once the plan period of time designated by the patient has ended, which addresses some patient's privacy concerns. The archived collected data is deleted once the period of time legally prescribed for maintaining medical records has lapsed, unless the patient has chosen an option to view them at a later date. Service employees collect a patient's medical data at a single point in time (e.g., once each day for three days), but service employees do not maintain a running database of the patient's medical data.

The on-line service of the present invention does not manage medical records for any patient. No criteria are used or required because the CZ service does not analyze, sort, classify, categorize, or organize the patient's medical data. It presents medical data to the patient as it is found, which is usually chronologically. Medical data/chart information is not changed by the present service.

The following are believed to be some of the unique features of the present system 10:

1. Date of destruction—The service website 31 recognizes the date that the client-patient's system chart 40 was started and holds the chart information for a pre-determined period of time before its removal from the system's archives 41. The period of time the patient's system chart 40 is held in the system's archives 41 depends upon the user's home state (e.g., 5 years or 7 years), since laws differ from state to state. At the end of the period required by law, the patient's chart 40 is deleted from the present system 10.

2. Service pricing plans 57—The service pricing plans 57 are designed for the amount of time that a person will be in the hospital, with the option to extend after the hospitalization period.

3. Retrieval service pricing plan 62—The service website 31 permits a past user to login (using the login web page 47) and obtain their old system chart 40 for a period of time. This ability to retrieve a several year old file, for example, is beneficial where a user has lost or forgotten some information from a previous hospitalization, or where a user wishes to compare current data (s)he is in possession of, such as a particular laboratory result, with past data from the period of time captured in his or her old system chart 40. The user can then compare the old result from the last time (s)he was in the hospital with the current lab result, for example.

4. Pairing information with mobile device 13—The system 10 permits the user to see his/her system chart 40 using his/her own Internet-accessible mobile device 13, such as an iPad, when it was entered on-line.

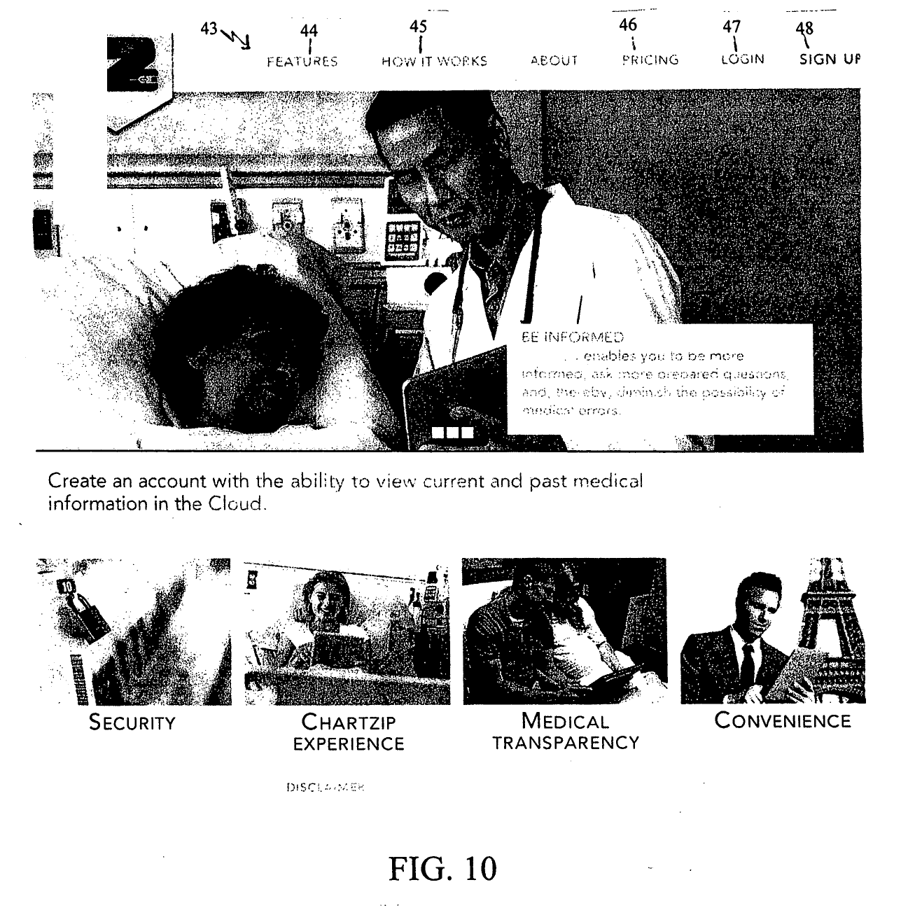

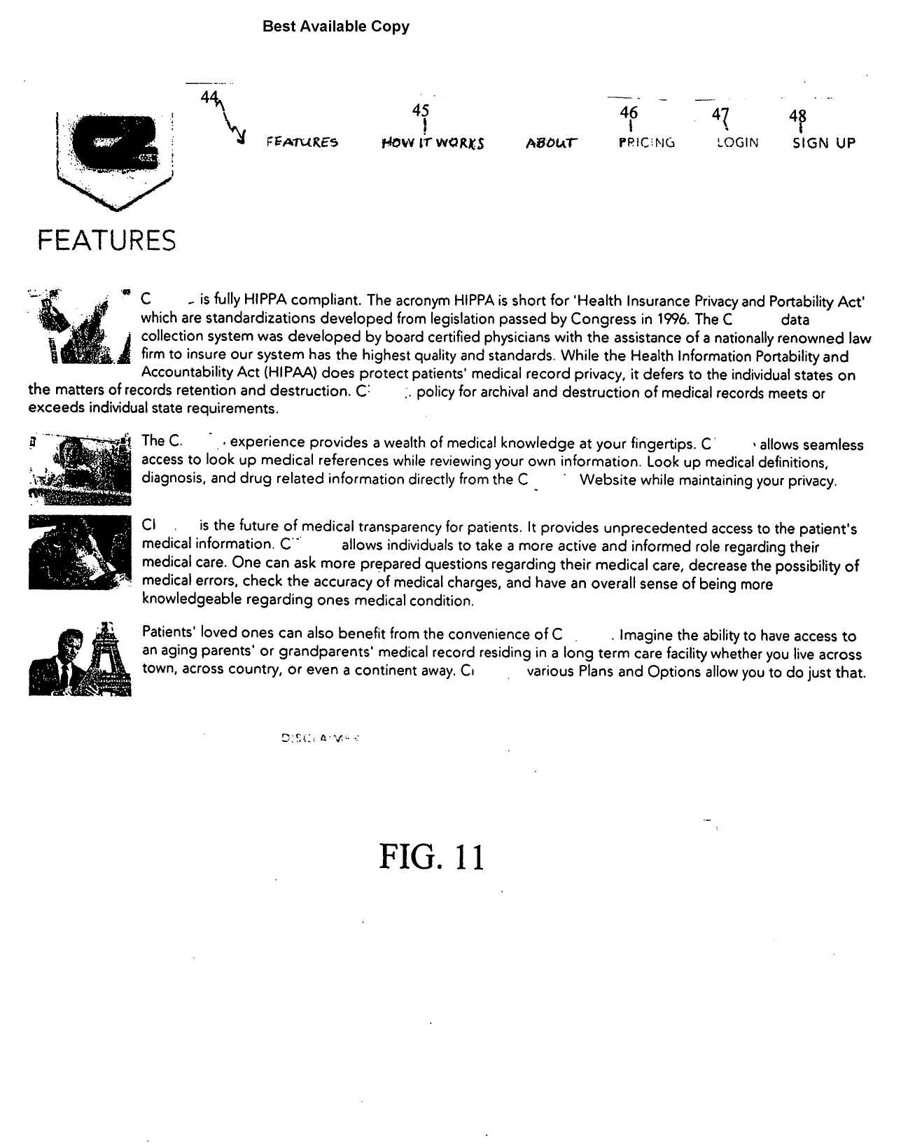

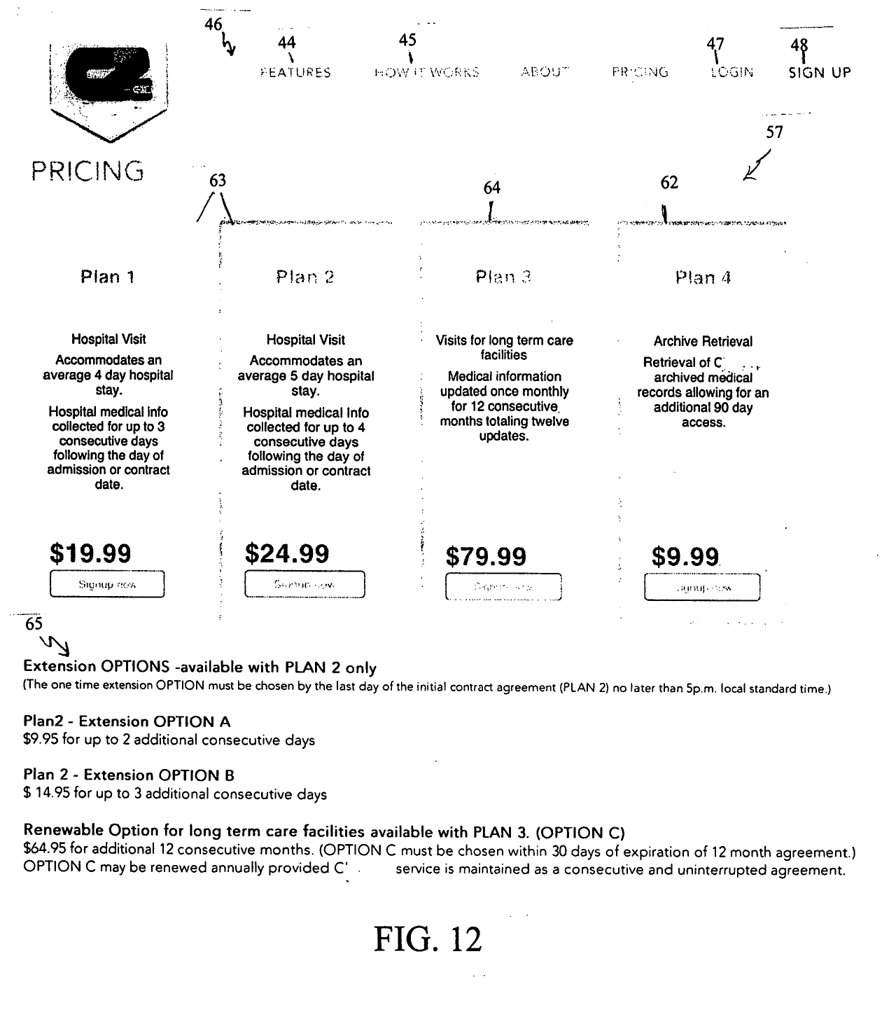

Turning to FIG. 10, a preferred sequence of steps in the present method is as follows. Using the Internet, the potential client logs onto the service's website address and the home page of the secure service website 31, including a disclaimer, is displayed. The system home page 43 preferably includes several (e.g., three) photos of model users of the present system 10, which rotate every few (e.g., four) seconds. The initial system page 43 offers: (a) a “Features” selection (“button”), which leads to a Features web page 44 with a discussion of the present (CZ) medical data delivery system 10, as seen in FIG. 11; (b) a “How It Works” selection, which leads to a How It Works web page 45 teaching how the CZ system 10 works; (c) a “Pricing” selection, which leads to a Pricing web page 46 displaying the service pricing plans 57 offered, as seen in FIG. 12; (d) a “Login” selection 47, which leads to a Login web page for logging in to CZ's system 10; and (e) a “Sign up” selection 48, which leads to a Sign up web page for signing up for the service of the present invention. Most web pages of the service website 31 preferably include a legal disclaimer, the mailing address of the service, and a copyright notice.

The Login web page displays blanks for entering an email address and a password, and touching the “Login” button on the Login page 47. The on-line system 10 compares the email address and password to its cumulative list and, if there is a match, passes the user through on the service website. The Login web page also includes a “Forget password?” selection, and a “Not a member yet?” selection that leads to the Sign up web page.

The on-line system 10 includes data fill-in blanks on the Sign up web page for filling in the patient's name and mailing address, phone number, email address, date of birth, gender, marital status, general health, admission date, and the name of the hospital she/he will be or has been admitted to. The Sign up web page also include a blank for entering the service pricing plan selection, and blanks for entering payment information. Once the blanks are filled in, the user clicks on a “Create button”.

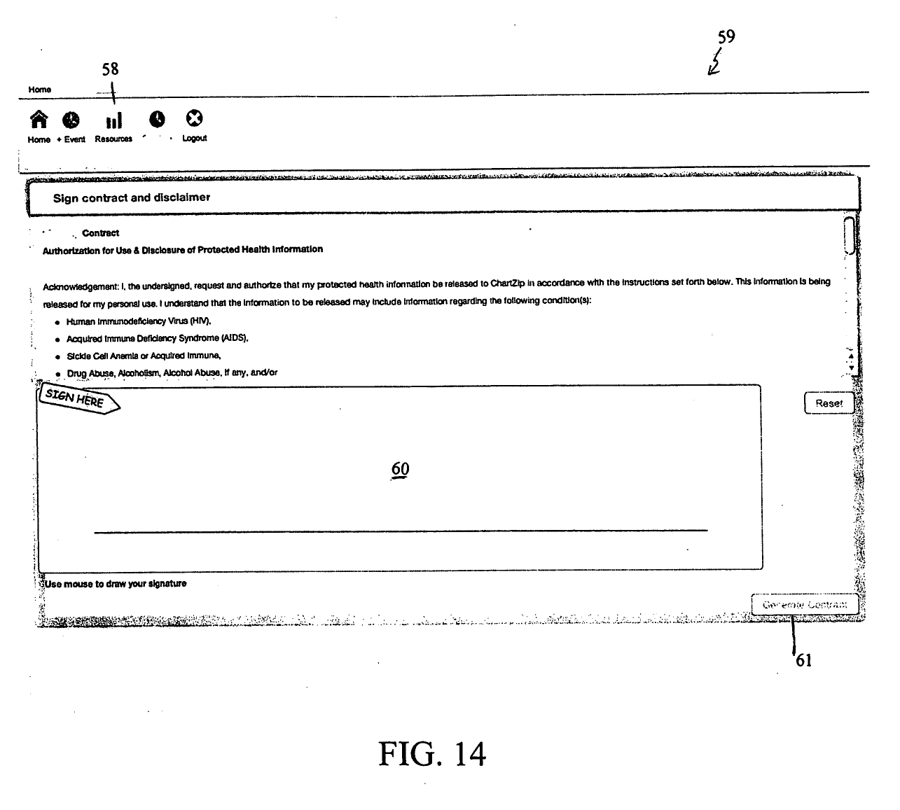

After pre-determined, required ones of the Sign in web page data blanks are filled in, the system 10 automatically presents a Contract web page 59 that displays a sign up contract and legal disclaimer, as seen in FIG. 14. The Contract web page 59 also includes a signature blank 60, preferably with an arrow sign saying “Sign Here”. The on-line system 10 has the capability for a computer mouse linked with the patient's Internet-accessible computerized mobile device 13 to be used for drawing a signature in the patient's signature blank 60 on the Contract web page 59. This drawn signature can be compared by the hospital or long term care facility to the patient's known signature, which cannot be done with an S-signature (eg., /John Doe/). At the bottom, the Contract web page 59 includes a “Generate Contract” button 61 for entering the drawn signature.

Once the “Generate Contract” button is touched, the system 10 enters the contract and disclaimer and automatically displays a message stating that contract downloading will begin in several seconds, and providing a link by which the contract/disclaimer can be accessed if downloading does not start. The on-line system 10 forwards the contract and disclaimer to the patient's earlier-provided email address, which fact is also stated in the automatic message. The system 10 then preferably automatically redirects the user to the system home page 43. The on-line system 10 automatically forwards the contract to the proper department at the patient's healthcare facility 20, which name was provided earlier by the patient (via the Sign up web page).

If “required” blanks in the registration page are not filled in, an “incomplete” message and the partially filled in registration page are displayed. If all of the “required” blanks in the registration page are filled in, the CZ contract web page 59 is displayed.

If “required” blanks on the Contract web page 59 are not filled in, an “incomplete” message and the partially filled in page are displayed. If required blanks in the contract, including signature, are filled in, a thank you email is sent to the patient's pre-submitted email address.

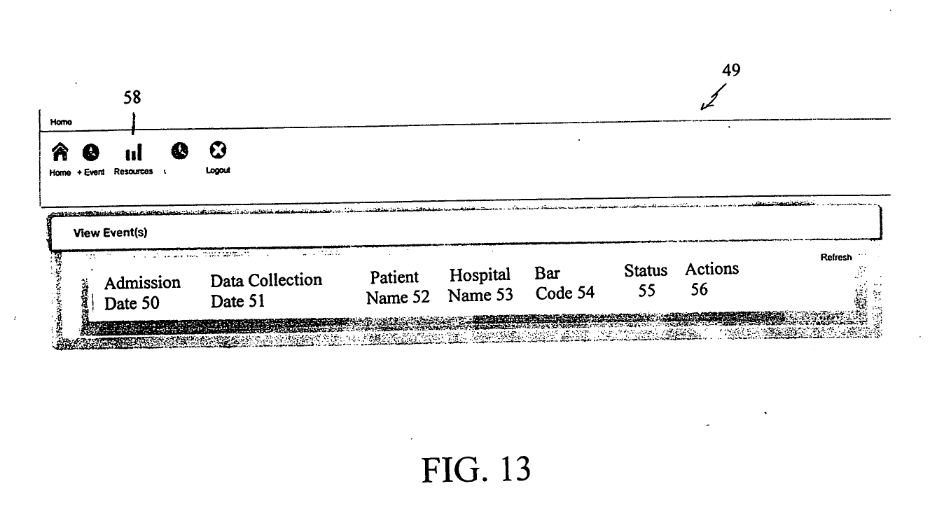

Once the user has entered sign-up information, an “Events” web page 49 automatically displays, as seen in FIG. 13. The Events web page 49 includes: (a) an Admissions Date 50 for the date of expected admission to the hospital or other medical facility, which is usually upcoming but may be contemporaneous; (b) the “Data Collection Date” 51, which is when the patient's medical data will be collected; (c) the patient name 52; and (d) the name of the hospital 53 where the patient expects to stay or is already admitted. Once the individual signs up for the service of the present system 10, the system 10 creates a Client system chart 40 for that Client 27, and assigns a unique bar code 54 for that client-patient 27. The Events web page 49 also includes (e) the bar code 54, (f) “Status” 55, where the client's status is displayed; and (f) “Actions” 56, where actions are displayed. In regard to the latter, “Actions” 56 may include the word “Purchase” for example, where the user has indicated interest but has not yet purchased a service plan 57. There are preferably three categories under Status 55: Active, View, and Archive. The bar code 54 speeds up hospital approval because it can be scanned and compared to a bar code for that patient in the system as a security measure.

CZ's service may be obtained by an individual expecting to enter a hospital or long term facility 20, but a CZ client may alternatively be a current inpatient. A patient's legal guardian may sign on with CZ in the patient's stead.

The Events web page 49 includes a “Resources” button 58 with a pull-down menu listing a selection of medicine-related resources, preferably including a Physicians Desk Reference, for the patient to look up medical terminology, particular drug contraindications, “normal” ranges for lab test results, etc. (see FIG. 13). Lastly, the Events web page 49 includes a Logout button for logging out.

In regard to the first item above: “date of destruction”, the initial Active Status extends from the date the client system chart 40 is created until the end of the plan period for that hospitalization/event. Alternatively, the start date may be the date the client contract was received by the system 10. The system 10 automatically starts a client system chart 40 once the client contract has been signed and entered. The system 10 prevents a client contract from being signed and entered until payment for a service pricing plan 57 has been received. The on-line system 10 does offer a retrieval plan 62, preferably one lasting 90 days, during which a client system chart 40 is transferred back to viewable status once the retrieval plan is selected and paid for. The retrieval service plan 62 preferably extends for 90 days, during which the client may view his/her system chart at any time during the 90 day period.

Archive Status extends from the end of the service plan period for the hospitalization to the end of the archive time period (e.g., seven years). The on-line system 10 tracks the time period during which the client system chart 40 is maintained and deletes the client system chart 40 at the end of a pre-determined period of time (e.g., seven years). At the end of the period, the on-line system 10 can hide the client system chart 40, where it cannot be viewed by the patient. Alternatively, the system 10 transfers the client system chart 40 to a different server where Archives hibernate. In the event that a retrieval plan 62 is purchased, an appropriate software program is used to bring the client chart 40 back to the server used by Active files.

If a client-patient 27 returns to the hospital 20 again later on, a second client system chart can be created, if the patient requests one via the service website 31. Thus, the on-line system 10 is capable of maintaining more than one client system chart 40 for a single patient. In the case of multiple charts 40, the pre-determined period runs separately for each chart 40. The system 10 is capable of monitoring a separate pre-determined time period for each chart 40. For example, a first client system chart 40 for a patient in Colorado will be maintained in the system 10 for seven years from the date of creation of the first client system chart 40, after which it will be removed from the system 10. The second client system chart for the same Colorado patient will be maintained for seven years, dating from the date the system creates the second client system chart. At the end of the seven years, it too will be deleted. The terms “patient” (at the healthcare facility 20), “client” (of the on-line service), and “user” (of the on-line system 10/service) are used interchangeably herein.

As seen in FIG. 12, service plans 57 available on the service website 31 include the following in addition to the retrieval service plan 62 for the patient's system chart 40 to be retrieved from system Archives 41, as seen in Block 116: (a) Hospital service plans 63 for average four or five day hospital stays, such as a four day service plan wherein hospital medical information is collected for up to three consecutive days following either the date of admission, or the date the contract is received. The patient has the opportunity to view his/her system chart 40 each of the three consecutive plan days. (b) A stay at a long term care facility, for example, a long term care facility service plan 64 for medical information with updates once monthly for 12 consecutive months totaling 12 updates (see FIG. 12).

The client-user 27 selects which service plan she/he desires. Service pricing plans 57 can vary. Extension service plans 65 for additional consecutive days, preferably two or three, are optionally available with the hospital stays if the extension option is chosen by the last day of the admission date or contract date, as seen in FIG. 12. There is also an extension service plan 65 option for the long term care facility plan 64 that extends the service plan an additional 12 consecutive months, providing that the long term care extension option is chosen within 30 days of expiration of the long term care facility service plan and continues uninterrupted from the first 12 month period. In the case of the long term care facility extension, medical information is updated once per month for the second 12 consecutive months totaling 12 updates. The on-line and speedy nature of the service herein makes these extension service plans 65 feasible, keeps costs down, and provides a needed service to the user. (“Service” herein refers to the service of the present invention.)

Once the CZ field engineer has gathered the hospital chart information and copied it into CZ's client system chart 40, the client system chart is complete for the day. The system 10 automatically emails the client with a message saying that the client's system chart 40 is ready for viewing. On the Events web page 49, preferably under “Status”, readiness of the client system chart 40 for viewing is indicated by a color change (e.g., blue to red) and the word “View” (in place of “Active”). The user can access the system chart 40 using the service website 31, viewing its various pages on the display screen of the user's own Internet-accessible computerized mobile device 13. The patient system chart 40 is updated each day of the plan period following the first 24 hours of the plan period, adding information received or found that day, such as the patient's lab results, results of medical procedures, nurse notes, etc. The on-line system 10 automatically generates a new notification email to the client each day of the plan period.

Thus, the on-line system 10 automatically starts a patient system chart 40 for the patient 27 in which, upon admission of the patient to the healthcare facility 20, medical data from the patient's healthcare facility 20 is collected and stored in the patient system chart 40. The service website 31 comprises a Sign up web page 48, and, after required Sign in web page data blanks are filled in, approved, and entered, the service website 31 automatically displays a Contract web page 59. The Contract web page 59 displays a sign-up contract and disclaimer with a signature blank for the patient 27 (see FIG. 14). The on-line system 10 has the capability for a computer mouse linked with the patient's Internet-accessible computerized mobile device 13 to be used for writing a signature in the patient's signature blank on the Contract web page 59. The on-line system 10 forwards the sign-up contract and disclaimer, once they have been signed and entered, to the patient's email address, which fact is stated in a message automatically displayed on the service website 31. The sign-up contract, once it has been signed and entered, is preferably automatically forwarded to the appropriate department at the patient's healthcare facility 20, although it could alternatively be printed and carried there by the patient 27.

Furthermore, once the patient system chart 40 is ready for viewing, an email is automatically sent to a patient's email address with a notification message that the patient service chart 40 is ready for viewing. The patient system chart 40 is viewable via the service website 31 (see Events web page 49 in FIG. 13) on a display screen of the patient's Internet-accessible computerized mobile device 13. The on-line system 10 includes an initial Active, pre-viewing status, and an Archive status in which the patient system chart 40 has been offered for viewing and then archived (see Events web page 49). The on-line system 10 automatically transfers the patient system chart 40 to Archives after the last day of a pre-determined plan period of time (e.g., four days). Archives is preferably on a separate server, or it may mean that the subject patient system chart is hidden from viewing. The on-line system 10 automatically tracks the period of time during which the client system chart 40 is maintained, and deletes (or otherwise removes) the client system chart 40 at the end of a pre-determined period of time.

In regard to the pricing plans, the service website 31 comprises a Pricing web page 46 with at least one service pricing plan 57. As seen in FIG. 12, preferred service pricing plans 57 include a hospital service plan 63 that extends for a hospital stay of between about three and five days, or a long term facility service plan 64 that covers a stay in a long term care facility for monthly chart updates up to one year, from a date of contract receipt or a date of admission (whichever is specified in the contract) to the healthcare facility 20. Under a preferred hospital service plan 63, the patient system chart 40 is updated each day of the specified period of the plan (e.g., four days), following the first 24 hours of the specified plan period. The Pricing web page also includes the archive retrieval plan 62 permitting a past user to login and view a patient system chart 40 from a previous stay of his/hers in a healthcare facility for the period of time specified by the service pricing plan.

From the foregoing it can be realized that the described method of the present invention may be easily and conveniently utilized as a system and method for providing a patient's medical data to the patient or his appointed representative. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 Medical data delivery system
11 Chart delivery system platform
12 Patient's computer
13 Patient's mobile device
14 Web server
15 OCR processing server
16 EMR integration server
17 Chart delivery system server
18 Chart delivery system datacenter firewall
19 Internet
20 Healthcare facility
21 Chart delivery system datacenter
22 Service computer
23 Service mobile devices
24 Healthcare facility LAN
25 Healthcare facility computer
26 Registration portion
27 Patient/Client
28 Chart delivery system office
29 Document scanning portion
30 Medical data delivery method
31 Service website
32 Healthcare facility EMR system
33 OCR processing portion
34 Chart delivery system EMR system integration
35 Accessing records portion
36 Service employee
37 Print files/documents
38 Primary care physician's office
39 Collected data
40 Client system chart
41 System archives
43 System initial page
44 Features web page
45 How It Works web page
46 Pricing web page
47 Login
48 Sign up
49 Events web page
50 Hospital admission date
51 Data collection date
52 Patient name blank
53 Hospital name blank
54 Bar code
55 Status
56 Actions
57 Service pricing plans
58 Resources
59 Contract web page
60 Contract signature blank
61 Generate Contract button
62 Retrieval service plan
63 Hospital service plan
64 Long term care facility service plan
65 Extension service plan

What is claimed is:

1. A method for on-line delivery of a patient's medical data to a patient, the method comprising the steps of: a) providing an Internet-accessible service website; b) providing at least one Sign-up web page on the Internet-accessible service website with a plurality of blanks for entering patient registration information, the patient registration information comprising the patient's email address, and the name of a healthcare facility at which the patient is registered for admission; c) providing a medical data request form with at least one signature blank on a Contract web page of the Internet-accessible service website; d) offering at least one service pricing plan on a Pricing web page of the Internet-accessible service website; and e) upon receipt of payment for the at least one service pricing plan and a signed medical data request form, creating an on-line patient system chart and loading medical data to it from a healthcare facility chart of the patient at the healthcare facility, the patient system chart being viewable on-line using an Internet-accessible computerized mobile device of the patient.

2. The method according to claim 1, further comprising the steps of: f) matching a portion of the patient registration information against a portion of patient information provided by the patient at admission at the healthcare facility; and g) if the patient registration information portion matches, emailing an approval of service message to the patient's email address.

3. The method according to claim 1, further comprising the steps, of: g) forwarding the signed medical data request form to the healthcare facility and waiting for an approval of the medical data request from the healthcare facility; h) once approval from the healthcare facility is received, collecting the medical data from the healthcare facility for the patient; and i) downloading the collected patient medical data to a server and collecting it in the patient system chart.

4. The method according to claim 1, further comprising the steps in step e) regarding medical data, of: downloading electronic medical data for the patient from a computer of the healthcare facility, and scanning or photographing print medical data for the patient from at least one non-electronic file of the healthcare facility, and forwarding medical data to the patient system chart.

5. The method according to claim 4, further comprising the step when downloading is complete, of: automatically emailing the patient's email address with a notification message that the patient system chart is ready for viewing, the patient system chart being viewable via the service website on a display screen of the patient's Internet-accessible computerized mobile device.

6. The method according to claim 5, further comprising the step of: j) updating the patient system chart at a designated frequency for the duration of the patient-designated block of time.

7. The method according to claim 6, further comprising the step of: k) at the end of the patient-designated block of time, archiving the patient medical data for a pre-determined period of time.

8. An on-line system for collecting and delivering patient medical data for access by a patient, the on-line system comprising: (a) at least one Internet-accessible patient service-capable Internet-accessible computerized mobile device, at least one healthcare facility Internet-accessible service computer associated with a computer at at least one healthcare facility and a secure Local Area Network at the at least one healthcare facility, and an Internet-accessible service computer and at least one service Internet-accessible computerized mobile device; (b) a service website accessible from the patient Internet-accessible computerized mobile device; (c) a service server linked to the Internet via a service datacenter firewall; and (d) the service computer being linked to a Web server, and at least one other server.

9. The system according to claim 8, wherein the at least one other server is an Optical Character Recognition processing server, and an Electronic Medical Record integration server.

10. The system according to claim 8, wherein the system automatically starts a patient system chart for the patient in which, upon admission of the patient to the healthcare facility, medical data from the patient's at least one healthcare facility is collected and stored in the patient system chart.

11. The system according to claim 10, wherein the service website comprises a Sign up web page, and, after required Sign in web page data blanks are filled in, approved, and entered, the service website automatically displays a Contract web page, the Contract web page displaying a sign-up contract and disclaimer with a signature blank for the patient.

12. The system according to claim 11, wherein the on-line system permits a signature to be written in the patient signature blank on the Contracts web page using a computer mouse linked with the patient's Internet-accessible computerized mobile device.

13. The system according to claim 11, wherein the on-line system automatically forwards the sign-up contract, once it has been signed and entered, to email addresses of the patient and the healthcare facility.

14. The system according to claim 8, wherein the at least one Internet-accessible computerized mobile device is a smartphone or a tablet computer.

15. The system according to claim 14, wherein the on-line system assigns a unique security bar code for the patient, the security bar code being displayed on an Events web page of the service website, the bar code being readable using the smartphone or tablet computer.

16. The system according to claim 8, wherein, once the patient system chart is ready for viewing, an email is automatically sent to a patient's email address with a notification message that the patient system chart is ready for viewing, the patient system chart being viewable via the service website on a display screen of the patient's Internet-accessible computerized mobile device.

17. The system according to claim 16, the on-line system further comprising an initial Active, pre-viewing status, and an Archive status in which the patient system chart has been archived after being offered for viewing, the on-line system automatically transferring the patient system chart to Archives after the last day of a pre-determined plan period of time, the on-line system automatically tracking the period of time during which the client system chart is maintained, and deleting the client system chart at the end of a pre-determined period of time.

18. The system according to claim 10, wherein the service website comprises a Pricing web page comprising at least one service pricing plan, the at least one service pricing plan being a hospital service plan that extends for a hospital stay of between about three and five days, or a long term facility service plan that covers a stay in a long term care facility for monthly chart updates up to one year, from a date of contract receipt or a date of admission to the healthcare facility.

19. The system according to claim 17, wherein the patient system chart is updated each day of a specified period of the hospital service plan following the first 24 hours of the specified plan period.

20. The system according to claim 18, wherein the Pricing web page comprises at least one service pricing plan, the at least one service pricing plan being an archive retrieval plan permitting a past user to login and view a patient system chart for a period of time specified by the service pricing plan.
